(19) United States
(12) Patent Application Publication
(10) Pub. No.: US 2024/0248900 A1
(43) Pub. Date: Jul. 25, 2024

(54) Correcting Misspelled User Queries of in-Application Searches

(71) Applicant: Adobe Inc., San Jose, CA (US)

(72) Inventors: Sanat Sharma, Austin, TX (US); Tracy Holloway King, Mountain View, CA (US); Ravindra Sadaphule, Cupertino, CA (US); Josep Valls Vargas, Santa Cruz, CA (US); Francois Guerin, San Francisco, CA (US); Chirag Arora, Union City, CA (US); Arpita Agrawal, San Jose, CA (US)

(73) Assignee: Adobe Inc., San Jose, CA (US)

(21) Appl. No.: 18/157,185

(22) Filed: Jan. 20, 2023

(51) Int. Cl. G06F 16/2457

(52) U.S. Cl. CPC G06F 16/24578

(57) ABSTRACT

Techniques for correcting misspelled user queries of in-application searches are described as implemented by a user query processing system, which is configured to receive a user query entered via a search feature of an application, and identify a misspelled token in the user query. Candidate tokens to replace the misspelled token are identified from a collection of tokens, and a ranking of the candidate tokens is generated using machine learning. A token is selected from the candidate tokens based on the ranking, and the selected token is output by the user query processing system.

### BACKGROUND

A typical computing device often includes multitude of different applications, examples of which include graphic design applications, photo editing applications, video editing application, stock image databases, and so on. These applications typically include a search feature that supports a user query to initiate a search for content, features, products, functions, and so on, which are made available by a respective application. To provide better search results, application search features typically implement spell correction functionality as part of the user query. However, conventional spell correction techniques implemented for in-application searches often lead to user frustration due to slow search (i.e. high latency times) and inability to correct application-specific spelling mistakes. Further, conventional spell correction mechanisms are often built and trained on a particular language (e.g., the English language) and face difficulties scaling to additional languages, thus surfacing inaccurate search results for user queries input in different languages

### SUMMARY

Techniques for correcting misspelled user queries of in-application searches are described herein. In an example, a computing device implements a user query processing system to receive a user query entered via a search feature of an application, and identify a misspelled token in the user query. A suggester module is employed to identify candidate tokens from a collection of tokens to replace the misspelled token. The collection of tokens is a library of correctly spelled tokens that includes tokens of different languages, and application-specific tokens, such as tokens corresponding to features of the application and tokens occurring in user queries of the application at a threshold rate. A machine learning ranker module is employed to generate a ranking of the correctly spelled candidate tokens based on ranking features, such as a frequency of occurrence of the candidate tokens in user queries entered via the search feature of the application, a quantity of search results of the application that the candidate tokens produces, and a click rate associated with the search results of the application that the candidate tokens produce. A candidate token is selected for output to the application based on the ranking. By way of example, the selected token is output to the application, causing the application to perform a search on an updated user query that includes the selected token, rather than the misspelled token.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of an environment in an example implementation for employing techniques described herein for correcting misspelled user queries of in-application searches.

FIG. 2 depicts a system in an example implementation showing operation of a database to employ techniques described herein.

FIG. 3 depicts a system in an example implementation showing operation of a suggester module and a machine learning ranker module.

FIG. 4 depicts a system in an example implementation showing operation of an override module.

FIG. 5 depicts a system in an example implementation showing operation of a training module to train a machine learning ranker module.

FIG. 6 is a flow diagram depicting a procedure in an example implementation for correcting misspelled user queries of in-application searches.

FIG. 7 is a flow diagram depicting a procedure in an example implementation for correcting misspelled user queries of in-application searches.

FIG. 8 is a flow diagram depicting a procedure in an example implementation for correcting misspelled user queries of in-application searches.

FIG. 9 illustrates an example system including various components of an example device that can be implemented as any type of computing device as described and/or utilized with reference to FIGS. 1-8 to implement embodiments of the techniques described herein.

### DETAILED DESCRIPTION

### Overview

Computing device applications typically include a search feature which enables a user of a respective application to search for content, features, products, functions, and so on, which are made available to the user by the respective application. Oftentimes, these “in-application” search features include spell correction functionality to improve search queries and corresponding search results. However, conventional spell correction techniques typically utilize end-to-end neural models to correct spelling errors. While neural models can improve spell correction accuracy when performed on long-form text where context is plentiful, these models show negligible accuracy improvement when performed in search environments where context is minimal. Moreover, neural model-based spellchecking techniques are slower than rule-based spellchecking techniques that do not utilize machine learning and/or neural models to correct spelling errors. Furthermore, conventional spellchecking models are typically built and trained on proper language syntax, punctuation, and capitalization for a particular language, and as a result, fail to correct application-specific words which oftentimes are not proper language words. Additionally, conventional spellchecking models further face difficulties addressing foreign words or proper nouns that do not follow common language rules.

Accordingly, techniques for correcting misspelled user queries of in-application searches are described herein to correct in-application searches with reduced search latency, improved accuracy in correcting application-specific spelling errors, and using a user query processing system that is scalable to different languages. In an example, a user query processing system receives a user query entered via a search feature of an application and identifies a misspelled token in the user query. The user query processing system leverages a suggester module to identify candidate tokens to replace the misspelled token from a collection of tokens. The collection of tokens is a library of correctly spelled tokens that includes tokens of different languages, e.g., proper English words, proper German words, proper Italian words, etc. Further, the collection of tokens includes application-specific tokens, such as features of the application, products associated with the application, functions of the application, and so on. Moreover, the collection of tokens includes tokens having a threshold frequency of occurrence in user queries entered via the search feature of the application.

The user query processing system builds a permutation index that includes permutations of individual tokens in the collection of tokens, and corresponding correctly spelled tokens. To generate the permutations of a respective token, the user query processing system uses a symmetric delete algorithm to generate permutations of the individual tokens that are one delete away from the respective token having the respective token prepended. For example, the permutations in the permutation index for the token “test” include “testest,” “testtst,” “testtet,” etc. To identify the candidate tokens, the suggester module generates token variations of the misspelled token for comparison against the permutation index. For example, the suggester module generates first token variations of the misspelled token that are one delete away from the misspelled token, e.g., the first token variations of the misspelled token “tedt” include “edt,” “tdt,” “tet,” and “ted.” At run time, the suggester module in one example performs deletes on the misspelled token, but not replaces, inserts, and transposes. Further, the suggester module identifies, as candidate tokens, individual tokens in the collection of tokens having corresponding permutations in the permutation index that match the first token variations.

In one or more implementations, the suggester module is configured to identify at least a threshold number of candidate tokens, e.g., at least three candidate tokens. Thus, in situations in which less than the threshold number of candidate tokens are identified, the suggester module generates second token variations of the misspelled token that are two deletes away from the misspelled token. Further, the suggester module identifies, as candidate tokens, additional individual tokens in the collection of tokens having corresponding permutations in the permutation index matching the second token variations.

The candidate tokens are provided to the machine learning ranker module which is configured to generate a ranking of the candidate tokens based on a plurality of ranking features. The ranking features include search statistics of the application. For example, the candidate tokens are ranked based on a frequency of occurrence of the candidate tokens in search queries entered via the search feature of the application, a quantity of search results of the application that the candidate tokens produce, and a click rate associated with the search results that the candidate tokens produce. Additionally or alternatively, the ranking features include linguistic features. By way of example, the candidate tokens are ranked based on a number edit distances the candidate tokens are away from the misspelled token, whether the candidate tokens are associated with a same language setting utilized by a user of the application that entered the user query, and phonetic similarity of the candidate tokens to the misspelled token.

The machine learning ranker module generates feature scores for each of the ranking features, normalizes the feature scores (e.g., between a value of zero and one), and vectorizes the normalized feature scores to a vector space. Further, the machine learning ranker module combines the feature scores to generate a replacement score for each of the candidate tokens. In one or more implementations, different weights are assigned to the different ranking features during training of the machine learning ranker module, and as such, feature scores derived from heavily weighted ranking features generate a larger portion of the replacement scores. A candidate token is selected for output to the application based on the ranking, e.g., a highest-ranked candidate token. By way of example, the selected token is output to the application, causing the application to perform a search on an updated user query that includes the selected token rather than the misspelled token.

In some scenarios, the suggester module is challenged to identify multi-word errors as a result of compounding or decompounding, e.g., “class mate” and “designfeature.” To address this challenge, the user query processing module is configurable to maintain a database of overrides which includes common multi-word errors entered via the search feature of the application and corresponding corrected token. Thus, prior to providing a misspelled token to the suggester module, the user query processing system searches the database of overrides for the misspelled token. If the misspelled token is included in the database of overrides, a corresponding corrected token is identified and provided for output to the application without identifying and ranking the candidate tokens. In contrast, if the misspelled token is not included in the database of overrides, candidate tokens to replace the misspelled token are identified and ranked, in accordance with the described techniques.

Notably, the user query processing system utilizes a hybrid spellchecking architecture including a non-machine learning approach for identifying the candidate tokens, and a machine learning approach for ranking the candidate tokens. By doing so, the described techniques improve computational speed over conventional techniques, which utilize end-to-end neural models, without sacrificing accuracy. Further, the user query processing system improves accuracy in correcting application-specific spelling errors. This accuracy improvement is achieved by utilizing various application-specific data, e.g., application-specific tokens included in the collection of tokens and the application-specific search statistics on which the candidate tokens are ranked. Moreover, the user query processing system generates the variations of the misspelled token using deletes, and not inserts, transposes, or replaces. By doing so, the user query processing system is scalable to multiple languages since the suggester module does not identify and inject language-specific characters into a misspelled token. Furthermore, the override module enables the user query processing system to correct multi-word errors with increased accuracy by populating the database of overrides with common multi-word errors and corresponding corrected tokens.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

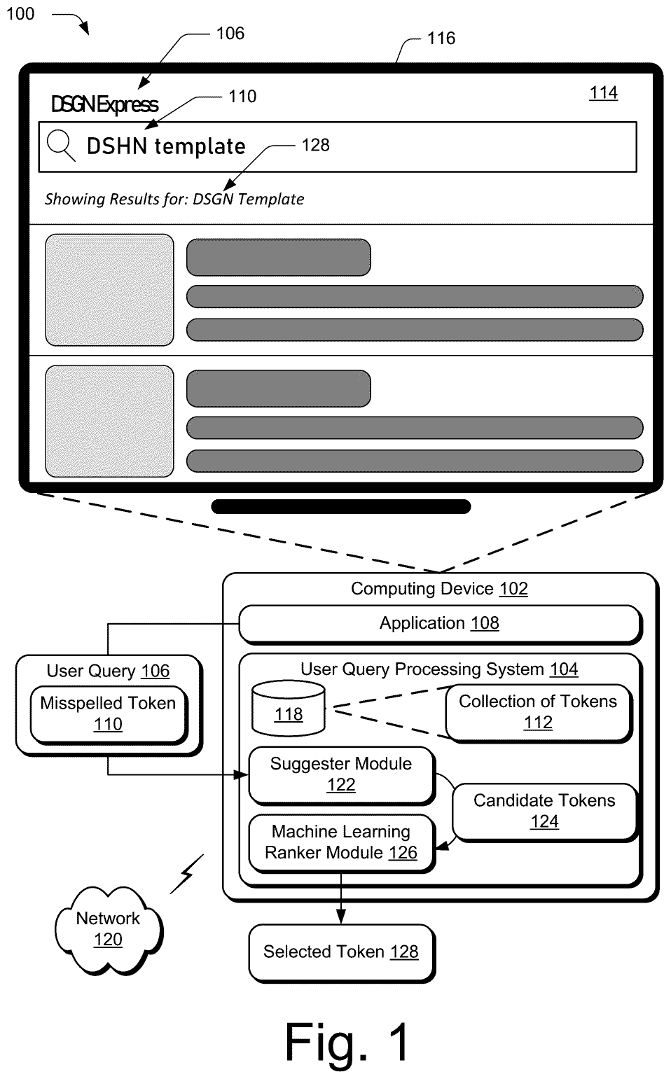

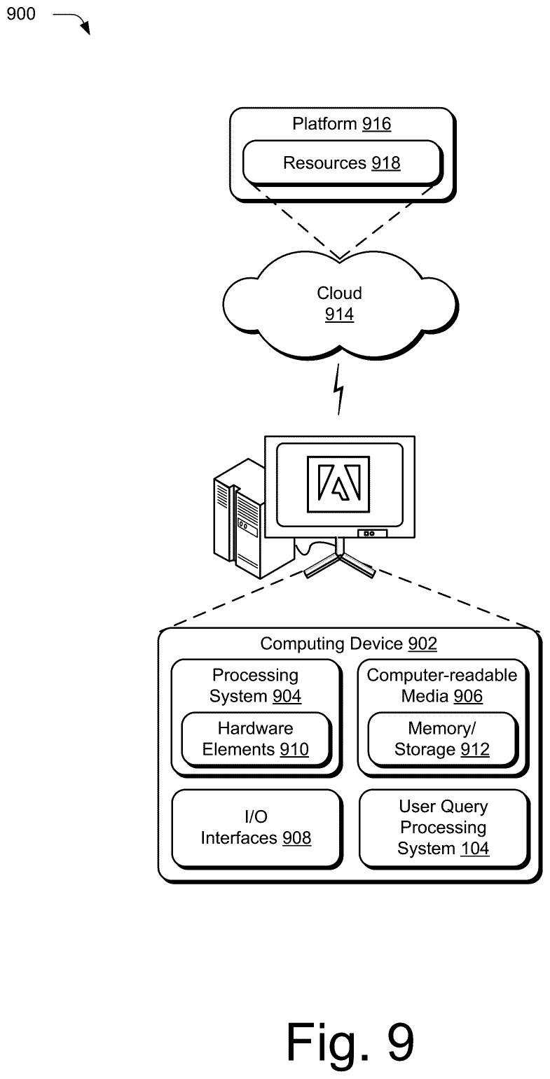

FIG. 1 is an illustration of a digital medium environment 100 in an example implementation for employing techniques described herein for correcting misspelled user queries of in-application searches. The illustrated environment 100 includes a computing device 102, which is configurable in a variety of ways. The computing device 102, for instance, is configurable as a desktop computer, a laptop computer, a mobile device (e.g., assuming a handheld configuration such as a tablet or mobile phone as illustrated), and so forth. Thus, the computing device 102 ranges from full resource devices with substantial memory and processor resources (e.g., personal computers, game consoles) to a low-resource device with limited memory and/or processing resources (e.g., mobile devices). Additionally, although a single computing device 102 is shown, the computing device 102 is also representative of a plurality of different devices, such as multiple servers utilized by a business to perform operations “over the cloud” as described in FIG. 9.

The computing device 102 is illustrated as including a user query processing system 104. The user query processing system 104 is implemented at least partially in hardware of the computing device 102 to process a user query 106 received via a search feature of an application 108. Such processing includes identification of a misspelled token 110 in the user query 106, selection of a token from a collection of tokens 112 to replace the misspelled token 110, and causing the application to render search results for a corrected user query that includes the selected token rather than the misspelled token 110 in a user interface 114 for output, e.g., by a display device 116. The collection of tokens 112 is illustrated as maintained in a database 118 of the computing device 102. Although illustrated as implemented locally at the computing device 102, functionality of the user query processing system 104 is also configurable as whole or part via functionality available via the network 120, such as part of a web service or “in the cloud.”

An example of functionality incorporated by the user query processing system 104 to process the user query 106 is illustrated as a suggester module 122. The suggester module 122 receives the user query 106 entered via the search feature of the application 108 and identifies candidate tokens 124 to replace the misspelled token 110 from the collection of tokens 112. Generally, the collection of tokens 112 is a database of correctly spelled tokens and includes application-specific tokens, such as tokens corresponding to features of the application 108, and tokens having a threshold frequency of occurrence in user queries entered via the search feature of the application 108. To identify the candidate tokens 124, the suggester module 122 generates variations of the misspelled token 110 and compares the variations to permutations of individual tokens in the collection of tokens 112, e.g., also stored in the database 118. The candidate tokens 124 are the individual tokens in the collection of tokens 112 having corresponding permutations matching the generated variations of the misspelled token 110.

A machine learning ranker module 126 is employed to generate a ranking of the candidate tokens 124. The ranking is based on application-specific search statistics, including but not limited to, a frequency of occurrence of the candidate tokens in user queries entered via the search feature of the application 108, a quantity of search results in the application 108 that the candidate tokens 124 produce, and a click rate associated with the search results of the application 108 that the candidate tokens 124 produce. Additionally or alternatively, the ranking is based on linguistic features associated with the candidate tokens 124. The user query processing system 104 further selects a candidate token 124 based on the ranking and outputs the selected token 128 to the application 108. By doing so, the application 108 performs a search on an updated user query that includes the selected token 128, rather than the misspelled token 110. As shown in the illustrated example, for instance, the user interface 114 of the application 108 displays search results for “DSGN template” rather than “DSHN template.”

Conventional spellchecking techniques typically utilize end-to-end neural models to correct spelling errors. While these models can improve spell correction accuracy when performed on long-form text where context is plentiful, these models show negligible accuracy improvement when performed in search environments where context is minimal, e.g., a typical user query is one to two words in length. Moreover, neural model-based spellchecking techniques are slower than rule-based spellchecking techniques that do not utilize machine learning and/or neural models to correct spelling errors. Furthermore, conventional spellchecking models are typically built and trained using proper language syntax, punctuation, and capitalization for a particular language, and as a result, fail to correct application-specific words which oftentimes are not proper language words, e.g., “DSGN.”

The user query processing system 104 improves computational speed over conventional techniques. This improvement in computational speed is achieved by the user query processing system 104 utilizing a hybrid spellchecking architecture to correct spelling errors in user queries. For example, the user query processing system 104 utilizes a non-machine learning spellchecking approach (e.g., employed by the suggester module 122) for identifying the candidate tokens 124, and a machine learning approach (e.g., employed by the machine learning ranker module 126) for ranking the candidate tokens. Furthermore, the user query processing system 104 improves accuracy in correcting application-specific spelling errors. This improvement in accuracy is achieved in one example by utilizing various application-specific data, e.g., application-specific tokens included in the collection of tokens 112 and application-specific search statistics on which the candidate tokens 124 are ranked.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### User Query Correction Features

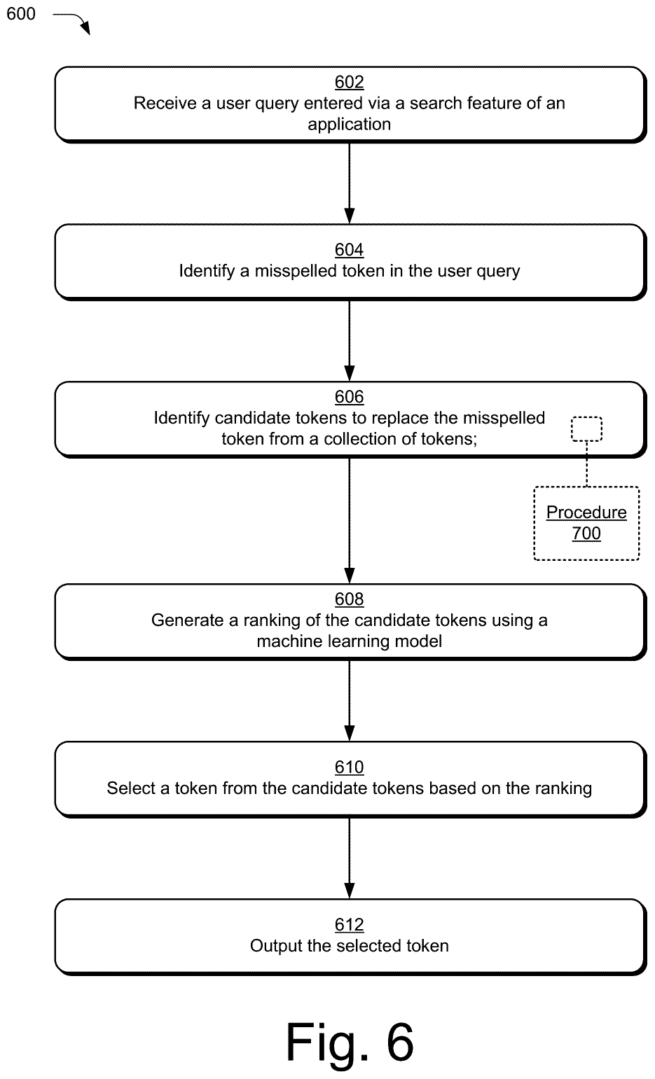

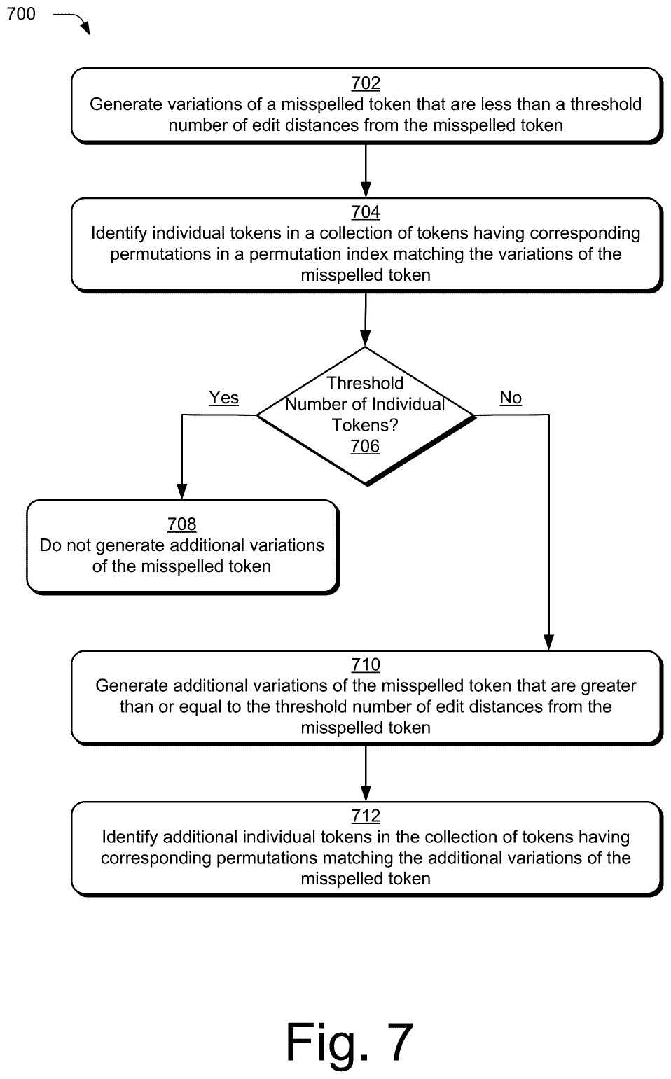

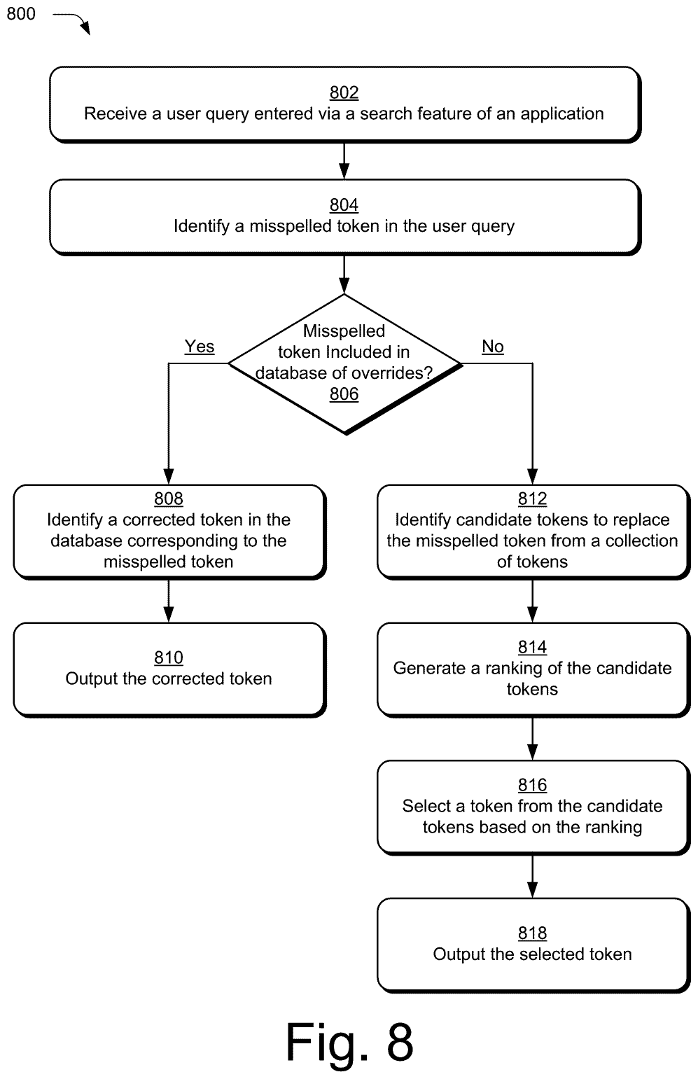

The following discussion describes techniques for correcting misspelled user queries of in-application searches that are implementable utilizing the previously described systems and devices. Aspects of each of the procedures are implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-5 in parallel with procedure 600 of FIG. 6, procedure 700 of FIG. 7, and procedure 800 of FIG. 8.

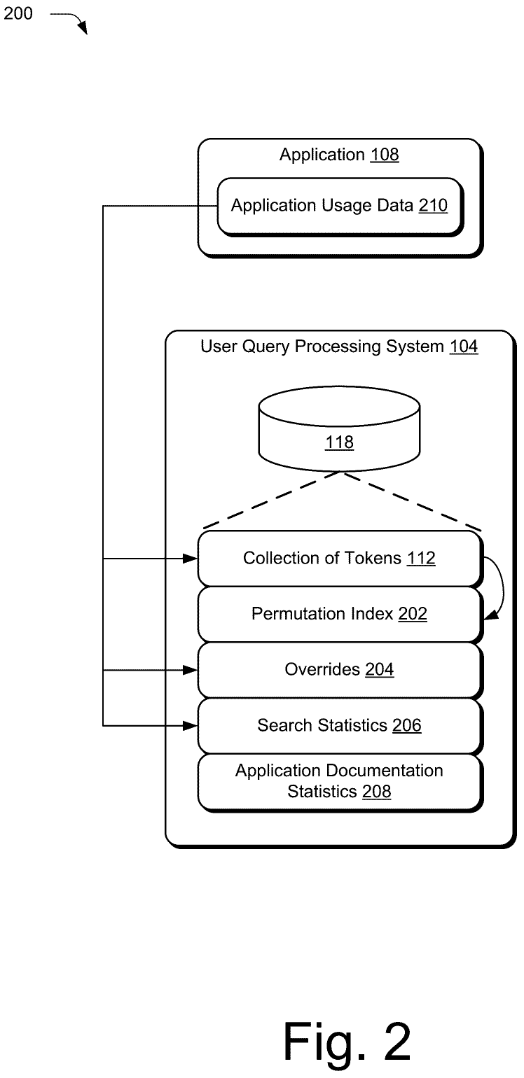

FIG. 2 depicts a system 200 in an example implementation showing operation of a database 118 to employ techniques described herein. As shown, the database 118 includes the collection of tokens 112, a permutation index 202, overrides 204, search statistics 206, and application documentation statistics 208. The collection of tokens 112 is a library of correctly spelled tokens and includes a plurality of tokens of multiple languages. By way of example, the collection of tokens 112 includes a plurality of proper English words, proper German words, proper Italian words, etc. It should be noted that the collection of tokens 112 includes tokens of any number of different languages without departing from the spirit or scope of the described techniques. In one or more implementations, the proper language words are obtained from known language dictionaries.

The collection of tokens 112 also includes application-specific terms, including application-specific product names, application-specific features, and application-specific functions. Consider an example in which the graphic design application “DSGN Express” includes an extension called “DSGN+,” and a design function called “Wrap-n-Rotate.” In this example, the terms “DSNG+” and “Wrap-n-Rotate” are included in the collection of tokens 112, despite not being proper language words.

The collection of tokens 112 includes tokens having at least a threshold frequency of occurrence in user queries entered via the search feature of the application 108. By way of example, the term “ICYMI” which is an acronym for “in case you missed it” is neither a proper language word nor a term that is specific to the application 108. Nevertheless, the term “ICYMI” appears in search queries entered via the search feature of the application 108 at a threshold rate, and as such, the term “ICYMI” is included in the collection of tokens 112. Additionally or alternatively, one or more of the application-specific terms are added to the collection of tokens 112 based on a frequency of occurrence of the application-specific terms in the user queries.

In one or more implementations, the application-specific terms are obtained from application data, rather than from user query data. By way of example, the application-specific terms are obtained from source code of the application 108 defining names of commands and/or functions of the application 108. Additionally or alternatively, the application-specific terms are obtained from user help documentation associated with the application 108. In this way, the collection of tokens 112 is populated with application-specific terms even when existing user query data is not available, e.g., when the application initially becomes available to users.

The user query processing system 104 is configured to build the permutation index 202 by generating permutations of individual tokens in the collection of tokens 112 and storing the permutations in the permutation index 202. To do so, the user query processing system 104 uses a symmetric delete algorithm in some implementations. Thus, for each token in the collection of tokens 112, the user query processing system 104 generates permutations of a respective token that are one delete (e.g., one edit distance) away from the respective token appended to the respective token. By way of example, the permutations in the permutation index 202 for the token “test” include “testest,” “testtst,” “testtet,”, etc. In the example, each permutation is the word “test” having a one-delete variation of the word “test” appended thereafter. In one or more implementations, the permutation index 202 is a hash table in which the permutations of the respective token are hashed using a hashing function.

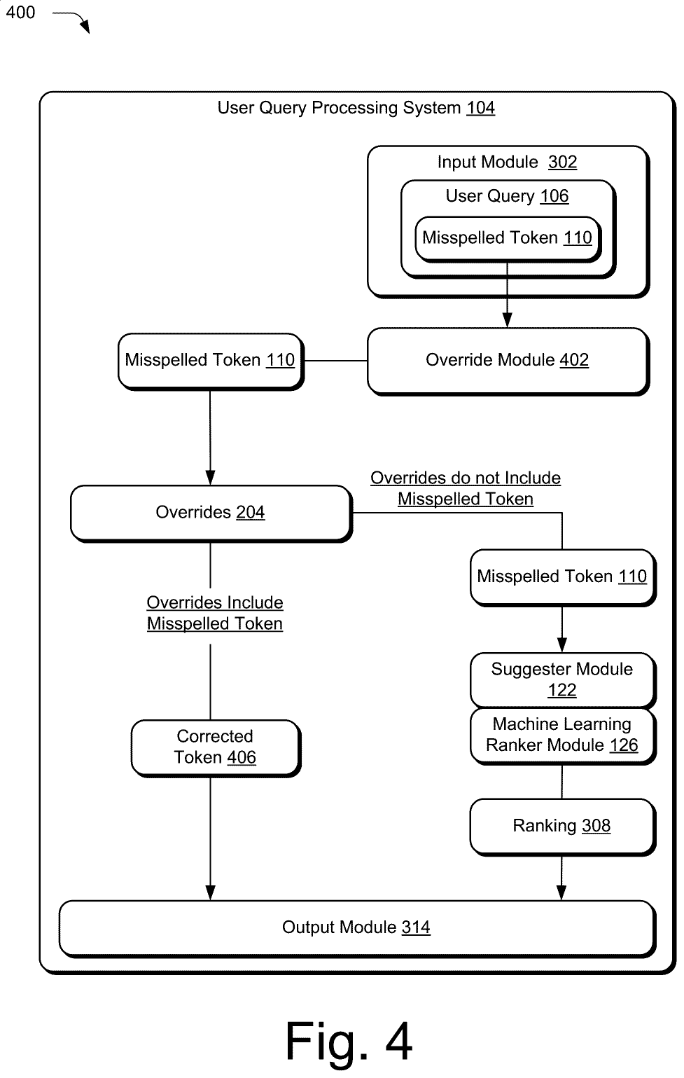

The overrides 204 include commonly misspelled tokens and corresponding corrected tokens. Broadly, when a misspelled token is identified in the overrides 204, the user query processing system 104 identifies a corrected token corresponding to the misspelled token 110, and outputs the corrected token without identifying or ranking the candidate tokens 124, as further discussed below with reference to FIG. 4. Due to the suggester module 122 generating delete-only variations to identify the candidate tokens 124, the suggester module 122 is challenged to identify candidate tokens 124 to replace multi-word errors caused by compounding or decompounding, e.g., “class mate” and “DSGNexpress.” Thus, the user query processing system 104 generates commonly misspelled tokens to include in the overrides 204 by injecting multi-word errors into correctly spelled tokens having at least a threshold frequency of occurrence in user queries entered via the search feature of the application 108.

Additionally or alternatively, the user query processing system 104 adds multi-word misspelled tokens to the overrides 204 having at least a threshold frequency of occurrence in user queries entered via the search feature of the application, e.g., the misspelled token 110 “DSGNexpress” occurs at least ten times in user queries entered via the search feature of the application 108. In one or more implementations, the user query processing system 104 adds singular word misspelled tokens to the overrides having at least a threshold frequency of occurrence in the user queries entered via the search feature of the application. Additionally or alternatively, the user query processing system 104 adds combinations of tokens to the overrides 204 which, when viewed individually are correctly spelled, but when viewed as a combination are incorrectly spelled, e.g., the combination of tokens “class mate.” In one or more implementations, the database of overrides 204 is a key-value map in which the keys are the common multi-word errors and the values are the corresponding corrected tokens.

The search statistics 206 includes various search-related information upon which the candidate tokens 124 are ranked by the machine learning ranker module 126. The search statistics 206, for instance, include a query count indicating words that have occurred in user queries entered via the search feature of the application 108 and corresponding frequencies of occurrence for each of the words. The search statistics 206 further include, for each word occurring in the user queries, a result count indicating a quantity of search results that a respective word produces. Furthermore, the search statistics 206 includes a click rate for the search results that each word produces. By way of example, the application 108 tracks clickstream data for search results indicating a frequency with which a respective search result is selected from a plurality of search results. The clickstream data is provided to the user query processing system 104, which generates click rates for each of the words occurring in the user queries based on the clickstream data. The click rate for a respective word is the combined frequency of selection for a subset of search results that a respective word produces, e.g., the search results corresponding to a first page of search results.

Additionally or alternatively, the search statistics 206 include query success statistics, such as purchases, downloads, streams, and exports resulting from a respective search term. By way of example, the clickstream data tracked by the application 108 further includes actions taken after a search result is selected from the plurality of search results, such as a purchase action, a download action, an action to stream content presented in the search result, and an action to export data from the search result. Therefore, the query success statistics for a respective word correspond to a frequency with which a user query that includes the respective word results in a purchase, download, stream, and/or export.

The application documentation statistics 208 indicate a frequency with which a particular term occurs in a document associated with the application 108. In one example, the application documentation statistics include a frequency with which a particular command or function appears within source code of the application. In another example, the documentation statistics include a frequency with which a word appears within user help documentation associated with the application 108.

As shown, the application 108 periodically provides application usage data 210 to the user query processing system 104, enabling the user query processing system 104 to update the collection of tokens 112, the permutation index 202, the overrides 204, and the search statistics 206. The application usage data 210, for instance, includes a set of user queries entered via the search feature of the application 108 over a preceding time interval, e.g., over the previous twenty-four hours. The user query processing system 104 identifies words in the user queries having at least a threshold frequency of occurrence, and adds the identified words to the collection of tokens 112. By doing so, the collection of tokens 112 is automatically updated to include terminology which was otherwise not available at a time the collection of tokens 112 was initially built, e.g., newly added application-specific features and products and new popular general language terms. Further, the user query processing system 104 generates permutations for the newly-added tokens and adds the permutations to the permutation index.

Based on the received set of user queries, the user query processing system 104 further updates the overrides 204 to include additional commonly misspelled tokens and corresponding corrected tokens. To do so, the user query processing system 104 identifies words in the user queries having at least a threshold frequency of occurrence. Further, the user query processing system 104 injects multi-word errors into the identified words, and adds the error-injected words and corresponding corrected token to the overrides 204. In one or more implementations, the threshold frequency of occurrence for updating the overrides 204 is higher than the threshold frequency of occurrence for updating the collection of tokens 112. Additionally or alternatively, the user query processing system 104 identifies multi-word errors and singular word errors that have occurred at least a threshold number of times in the set of user queries, and adds the common errors to the overrides 204 along with corresponding corrected tokens.

In addition to the set of user queries, the application usage data 210 further includes search statistics collected over the preceding time interval, including updates to search results that individual tokens produce, and clickstream data indicating user interactions with the search results that the individual tokens produce. Accordingly, the user query processing system 104 updates the query count based on the set of user queries entered over the preceding time interval, the user query processing system 104 updates the result count based on the updates to the search results that the individual tokens produce, and the user query processing system 104 updates the click rate and the query success statistics based on the clickstream data collected over the preceding time interval.

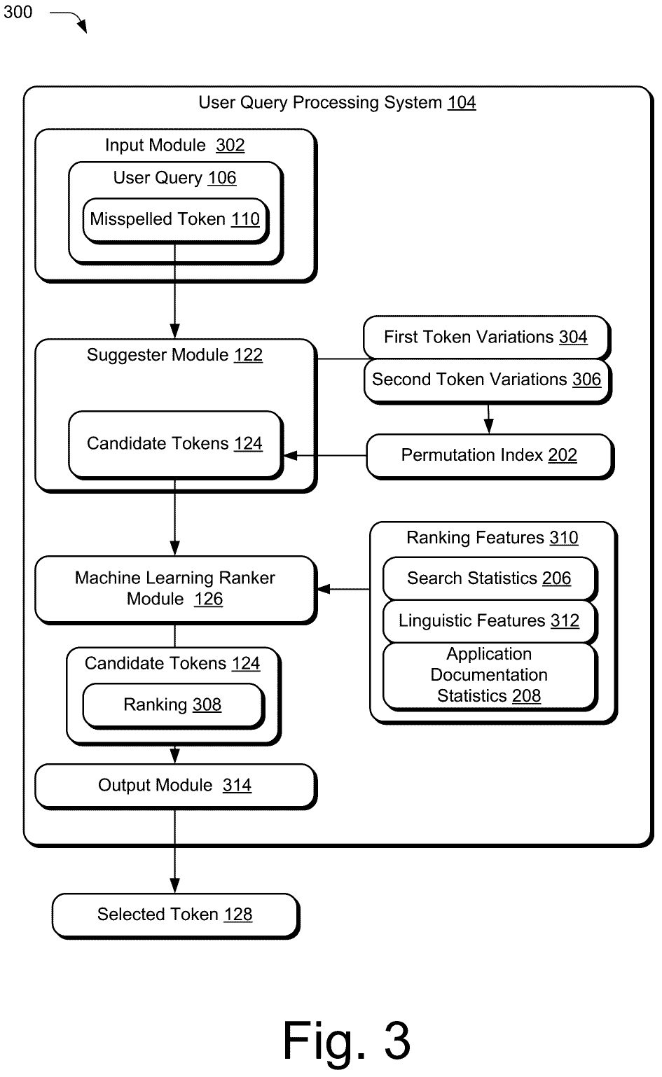

FIG. 3 depicts a system 300 in an example implementation showing operation of a suggester module 122 and a machine learning ranker module 126. As shown, an input module 302 receives the user query 106 entered via the search feature of the application 108 (block 602 of FIG. 6). Further, the input module 302 is configured to identify a misspelled token 110 in the user query 106 (block 604). To do so, the input module 302 compares the tokens in the user query 106 to the collection of tokens 112. If a token in the user query 106 does not match any individual token in the collection of tokens 112, then the input module 302 determines that the token is a misspelled token 110. In one or more implementations, the input module 302 identifies one or more correctly spelled tokens in the user query 106, e.g., if a token in the user query 106 matches an individual token in the collection of tokens 112. Misspelled tokens 110 in a user query are provided to the suggester module 122 while correctly spelled tokens are not. Thus, candidate tokens 124 are neither identified nor ranked for correctly spelled tokens in the user query 106.

Broadly, the suggester module 122 receives a misspelled token 110 and identifies candidate tokens 124 from the collection of tokens 112 to replace the misspelled token 110 (block 606). To identify the candidate tokens 124, the suggester module 122 generates first token variations 304 of the misspelled token 110 that are less than a threshold number of edit distances from the misspelled token 110 (block 702 of FIG. 7). In a specific example, the suggester module 122 generates first token variations 304 that are one edit distance from the misspelled token 110, e.g., less than a threshold of two edit distances away. As previously discussed, the suggester module 122 utilizes a symmetric delete algorithm in some implementations, and as such, the suggester module 122 performs deletes on the misspelled token 110 to generate token variations, but does not perform other edit types, such as transposes, replaces, and inserts. In an example in which the misspelled token 110 is “tedt,” the first token variations 304 generated by the suggester module 122 are “edt,” “tdt,” “tet,” and “ted.”

The suggester module 122 identifies, as the candidate tokens 124, individual tokens in the collection of tokens 112 having corresponding permutations in the permutation index 202 that match the first token variations 304 (block 704). As previously discussed, the permutations of a respective token in the permutation index 202 are the respective individual token in the collection of tokens 112 having a one-delete variation of the respective individual token appended. Therefore, the token “tent” includes the permutation “tenttet” in the permutation index 202, and the token “test” includes the permutation “testtet” in the permutation index 202. Continuing with the previous example in which the misspelled token 110 is “tedt,” both “tent” and “test” include a permutation in the permutation index 202 that includes the combination of characters “tet.” Since the combination of characters “tet” matches a first token variation 304 of the misspelled token “tedt,” the suggester module 122 identifies candidate tokens 124 including the tokens “tent” and “test.” As previously mentioned, the permutation index 202 is a hash table in some implementations, and as such, a search time to search for permutations in permutation index 202 is independent of the number of permutations in the permutation index 202.

In one or more implementations, the suggester module 122 is configured to determine whether a threshold number of candidate tokens are identified based on the first token variations 304 (decision block 706). By way of example, the suggester module 122 is configured to identify at least three candidate tokens 124 to provide to the machine learning ranker module 126. In some situations, at least the threshold number of the candidate tokens 124 are identified based on the first token variations (i.e., “Yes” at decision block 706), and the suggester module 122 does not generate additional variations of the misspelled token 110 that are greater than or equal to the threshold number of edit distances from the misspelled token 110 (block 708). By way of example, the suggester module 122 identifies three or more candidate tokens 124 based on the first token variations 304, and as such, does not generate additional variations which are two or more edit distances from the misspelled token 110.

In some situations, however, the candidate tokens 124 identified from the first token variations 304 are less than the threshold number of candidate tokens 124 (i.e., “No” at decision block 706). By way of example, the first token variations 304 produce two candidate tokens 124. In these situations, the suggester module 122 generates second token variations 306 that are greater than or equal to the threshold number of edit distances (e.g., deletes) from the misspelled token 110 (block 710).

In accordance with the previous example, the suggester module 122 generates second token variations that are two deletes away from the misspelled token 110. Thus, in the previous example in which the misspelled token 110 is “tedt,” the second token variations 306 include “te,” “ed,” “dt,” “td,” “et,”, and “tt.” Further, the suggester module 122 searches the permutation index 202 for permutations of tokens in the collection of tokens 112 that match the second token variations 306. Moreover, the suggester module 122 identifies, as the candidate tokens 124, additional individual tokens in the collection of tokens 112 having corresponding permutations in the permutation index 202 that match the second token variations 306 (block 712), in a similar manner to that discussed above with respect to the first token variations 304.

Notably, searching both the first token variations 304 and the second token variations 306 in the permutation index 202 leads to a greater quantity of candidate tokens 124, and as such, leads to increased accuracy in selecting candidate tokens 124 to replace the misspelled token 110. However, this search technique also increases the number of token variations that are included as part of the search for candidate tokens, especially when considering that a larger number of edit distances leads to a larger number of possible token variations. Given this, searching both the first token variations 304 and the second token variations 306 increases search latency, as compared to searching just the first token variations 304. Thus, the suggester module 122, in an implementation, generates and searches the second token variations 306, solely, in situations in which the first token variations 304 produce an insufficient number of candidate tokens 124. In at least one implementation, the suggester module 122 does not generate additional token variations that are greater than two edit distances away, regardless of whether a threshold number of candidate tokens 124 are identified based on the first and second token variations 304, 306, thereby limiting the increase in search latency.

By using the symmetric delete algorithm, the user query processing system 104 is computationally faster than other spellchecking algorithms which perform transposes, replaces, and inserts at run time, in addition to deletes. This is because deletes are computationally inexpensive in comparison to other edit types. Moreover, the symmetric delete algorithm is language independent enabling the user query processing system 104 to be scaled to multiple languages. This is because the suggester module 122 does not identify language-specific characters to inject into the misspelled token 110.

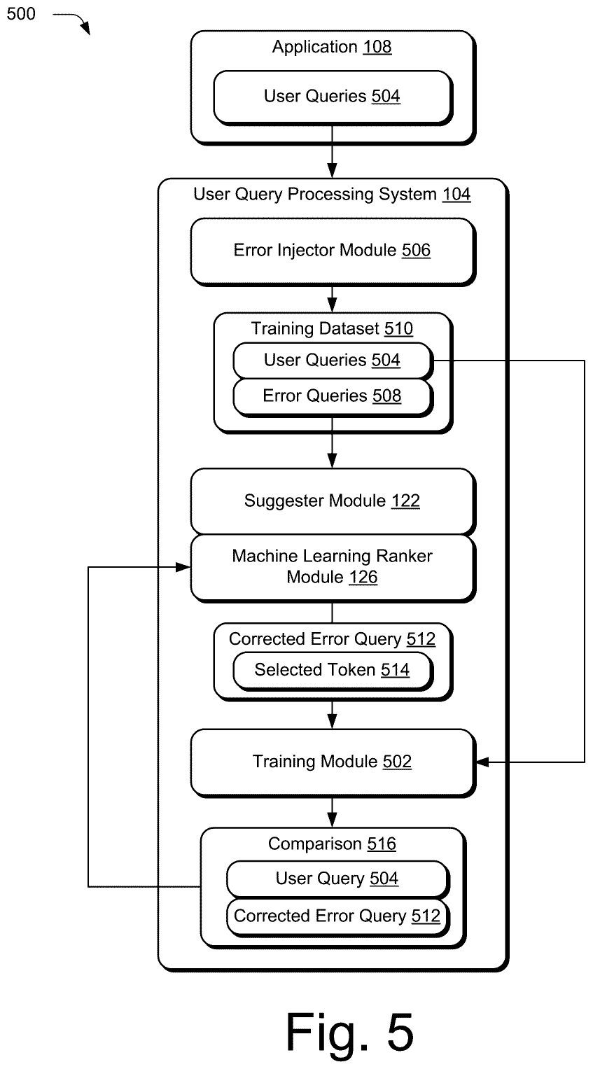

The suggester module 122 provides the candidate tokens 124 to the machine learning ranker module 126, which is configured to generate a ranking 308 of the candidate tokens 124 using machine learning (block 608). In one or more examples, the machine learning ranker module 126 includes one or more multi-layer perceptron (MLP) artificial neural networks trained to generate the ranking 308 of the candidate tokens 124 based on a plurality of ranking features 310, as further discussed below with reference to FIG. 5. Conventional spellchecking techniques often use recurrent neural networks or transformer machine learning models to correct spelling errors, which are typically slower than MLP networks. Thus, by utilizing one or more MLP networks, the machine learning ranker module 126 is able to rank and select a candidate token to replace the misspelled token 110 with reduced latency, as compared to conventional techniques. To rank the candidate tokens 124, the machine learning ranker module 126 determines a plurality of feature scores for each of the candidate tokens 124 based on the plurality of ranking features 310.

As shown, the ranking features 310 include the search statistics 206, such as query count, result count, click rate, and query success statistics. Therefore, the machine learning ranker module 126 generates a query count score for each of the candidate tokens 124. Candidate tokens 124 having a higher frequency of occurrence in user queries entered via the search feature of the application 108, as indicated by the search statistics 206, are assigned a higher query count score. Further, the machine learning ranker module 126 generates a result count score for each of the candidate tokens 124. Candidate tokens 124 that produce a larger quantity of search results in the application 108, as indicated by the search statistics 206, are assigned a higher result count score. Moreover, the machine learning ranker module 126 generates a click rate score for each of the candidate tokens 124. Candidate tokens 124 having a subset of search results produced by the candidate tokens 124 (e.g., a first page of search results) with a higher click rate, as indicated by the search statistics 206, are assigned a higher click rate score. Furthermore, the machine learning ranker module 126 generates a query success score for each of the candidate tokens 124. Candidate tokens 124 that, when searched, result in more frequent purchases, downloads, streams, and/or exports, as indicated by the search statistics 206, are assigned a higher query success score.

Additionally or alternatively, the ranking features 310 include linguistic features 312, such as edit distance, language locale, and phonetic similarity. Thus, the machine learning ranker module 126 generates an edit distance score for each of the candidate tokens 124. The candidate tokens 124 that are a smaller number of edit distances from the misspelled token 110 are assigned a higher edit distance score. In some implementations, the candidate tokens 124 include tokens of multiple languages since the user query processing system 104 is configured to correct spelling mistakes for multiple languages. Thus, the machine learning ranker module 126 is configured to generate a language locale score for each of the candidate tokens 124. To do so, the machine learning ranker module 126 identifies a language setting of the application 108 used by a user that entered the user query 106, e.g., based on metadata of the user query 106. Further, the machine learning ranker module 126 compares the language setting of the application 108 to the language of the candidate tokens 124. Candidate tokens 124 included in a same language as the language setting are assigned a higher language locale score.

The machine learning ranker module 126 further generates a phonetic similarity score for each of the candidate tokens 124 in some implementations. Phonetic similarity is a degree to which multiple words or portions of words sound similar when spoken. For example, the correctly spelled token “sandwich” has a high degree of phonetic similarity with the incorrectly spelled token “sandwitch.” Candidate tokens 124 that have a higher degree of phonetic similarity are assigned higher phonetic similarity scores.

In one or more implementations, the machine learning ranker module 126 is configured to rank candidate tokens 124 that are associated with multiple related applications 108, e.g., multiple applications that are made available by a same service provider. For example, the collection of tokens 112 includes tokens that are associated with a first application and tokens that are associated with a second application. Given this, the candidate tokens 124 include tokens associated with a first application and tokens associated with a second application, in some implementations. In these implementations, the machine learning ranker module 126 is configured to generate an application score for each of the candidate tokens 124. To do so, the machine learning ranker module 126 compares the application 108 from which the user query 106 was received to applications associated with the candidate tokens 124. Consider an example in which the user query 106 was received from the first application, rather than the second application. In this example, candidate tokens 124 associated with the first application are assigned a highest application score, candidate tokens 124 that are not associated with either the first application or the second application (e.g., application-independent tokens) are assigned lower application scores, and candidate tokens 124 that are associated with the second application are assigned a lowest application score.

Additionally or alternatively, the ranking features 310 include the application documentation statistics 208. For example, the machine learning ranker module 126 generates a documentation frequency score for each of the candidate tokens 124. Candidate tokens 124 that occur more frequently in application documentation (e.g., user help documentation associated with the application 108 and/or source code associated with the application 108) are assigned higher documentation frequency scores.

The machine learning ranker module 126 further scales each of the feature scores to a normalized value, e.g., a number between zero and one. By doing so, the machine learning ranker module 126 reduces and even eliminates an effect of numerical ranking features 310, such as the query count, the result count, and the click rate from dominating the ranking 308. Further, the machine learning ranker module 126 converts each of the feature scores to vectors in a vector space. Replacement scores are determined for each of the candidate tokens 124 by combining each of the normalized and vectorized feature scores of the candidate tokens 124. In one or more implementations, different weights are assigned to each of the ranking features 310, and as such, heavily weighted ranking features 310 generate a larger portion of the replacement scores for the candidate tokens 124. In at least one example, the different weights assigned to the different ranking features 310 are determined during training of the machine learning ranker module 126, as further discussed below with reference to FIG. 5.

The machine learning ranker module 126, in one example, generates the ranking 308, e.g., from candidate tokens having relatively higher replacement scores to candidate tokens having relatively lower replacement scores. It is to be appreciated that any one or any combination of the foregoing ranking features 310 and corresponding feature scores are utilized by the machine learning ranker module 126 to generate the ranking 308 of the candidate tokens 124 in variations. By ranking the candidate tokens 124 based on features of the candidate tokens 124 rather than the characters that make up the candidate tokens 124, the machine learning ranker module 126 ranks candidate tokens 124 to replace unseen misspelled tokens 110 (e.g., which were not exposed to the machine learning ranker module 126 during training) with increased accuracy.

Further, the machine learning ranker module 126 provides the ranking 308 of the candidate tokens 124 to the output module 314, which is configured to select a token from the candidate tokens based on the ranking (block 610). By way of example, the output module 314 selects a candidate token 124 having a highest replacement score from the candidate tokens 124. Further, the output module 314 outputs the selected token 128 (block 612). The selected token 128, for instance, is provided to the application 108, which performs a search on an updated user query that includes the selected token 128 rather than the misspelled token 110.

FIG. 4 depicts a system 400 in an example implementation showing operation of an override module 402. As shown, the input module 302 receives the user query 106 entered via the search feature of the application (block 802 of FIG. 8). The input module 302 further identifies the misspelled token 110 in the user query 106 (block 804), as previously discussed. However, rather than provide the misspelled token 110 to the suggester module 122, the input module 302 provides the misspelled token 110 to the override module 402. Broadly, the override module 402 is configured to determine whether the overrides 204 include the misspelled token 110 (decision block 806). As previously mentioned, the overrides 204 include commonly misspelled tokens and corresponding corrected tokens. In variations, the commonly misspelled tokens correspond to or include frequently searched correctly spelled tokens having multi-word errors injected, common multi-word misspelled tokens that are frequently entered via the search feature of the application, and/or common singular word misspelled tokens that are frequently entered via the search feature of the application. Thus, upon receiving the misspelled token 110, the override module 402 searches the overrides 204 for entries that match the misspelled token 110.

If the overrides 204 include the misspelled token 110 (i.e., “Yes” at decision block 806), then the override module 402 identifies a corrected token 406 in the database of overrides 204 corresponding to the misspelled token 110 (block 808). Further, the override module 402 provides the corrected token 406 to the output module 314, which outputs the corrected token 406 (block 810). For example, the output module 314 outputs the corrected token 406 to the application 108, which performs a search on an updated user query that includes the corrected token 406 rather than the misspelled token 110. In doing so, the override module 402 bypasses identifying the candidate tokens 124 from the collection of tokens 112 to replace the misspelled token 110 and further bypasses the ranking of the candidate tokens 124.

If, however, the overrides 204 do not include the misspelled token 110 (i.e., “No” at decision block 806), then the user query 106 including the misspelled token 110 is provided to the suggester module 122, which identifies candidate tokens 124 from the collection of tokens 112 to replace the misspelled token 110 (block 812), as further discussed above with reference to FIG. 3. Further, the candidate tokens 124 are provided to the machine learning ranker module 126 which generates a ranking 308 of the candidate tokens 124 (block 814), as further discussed above with reference to FIG. 3. Moreover, the ranking 308 is provided to the output module 314, which selects a token from the candidate tokens 124 based on the ranking (block 816), and outputs the selected token 128 (block 818), as further discussed above with reference to FIG. 3.

In one or more implementations, the user query 106 includes multiple correctly spelled tokens which when viewed individually are correctly spelled, but when viewed as a combination are misspelled, e.g., “class mate.” Thus, the override module 402 searches the overrides 204 for entries that match combinations of correctly spelled tokens in the user query 106, in some implementations. If the overrides 204 include the combination of correctly spelled tokens (e.g., “class mate”), then the override module 402 identifies a corresponding corrected token (e.g., “classmate”) in the overrides 204 and provides the corrected token to the output module 314 for output.

Since the suggester module 122 generates token variations that include only deletes, the suggester module 122 struggles to identify multi-word errors. Thus, the override module 402 is able to identify a corrected token 406 without leveraging the suggester module 122 by populating a database of overrides with common multi-word errors and corresponding corrected tokens 406. Populating the database in this way operates to correct multi-word errors with increased accuracy. Further, by bypassing the suggester module 122 and the machine learning ranker module 126, the override module 402 is able to avoid identifying and ranking the candidate tokens 124, thereby decreasing search latency in situations in which the misspelled token 110 is identified in the overrides 204.

In one or more implementations, the input module 302 identifies more than one misspelled token 110 in the user query 106. In these implementations, the user query processing system 104 performs the above-described operations on the multiple misspelled tokens 110, e.g., identifying a set of candidate tokens 124 to replace each of the multiple misspelled tokens 110, generating a ranking 308 of each set of the candidate tokens 124, and selecting a candidate token 124 to replace each of the misspelled token 110. Additionally or alternatively, for at least one of the multiple misspelled tokens 110, the override module 402 identifies at least one corrected token 406 in the overrides to replace the at least one misspelled token 110. Further, the output module 314 outputs the one or more selected tokens 124 and/or the one or more corrected tokens 406 to the application 108, which performs a search on an updated user query that includes the one or more selected tokens 124 and/or the one or more corrected tokens 406 rather than the multiple misspelled tokens 110.

FIG. 5 depicts a system 500 in an example implementation showing operation of a training module 502 to train a machine learning ranker module 126. Broadly, the machine learning ranker module 126 utilizes algorithms to learn from, and make predictions on, known data by analyzing the known data to learn to generate outputs that reflect patterns and attributes of the known data. For example, the machine learning ranker module 126 corresponds to or includes decision trees, support vector machines, linear regression, logistic regression, Bayesian networks, random forest learning, artificial neural networks, and so forth. In one or more implementations, the machine learning ranker module 126 employs one or more multi-layer perceptron (MLP) artificial neural networks. During training, the training module 502 adjusts one or more weights associated with the layers of the one or more MLPs of the machine learning ranker module 126 to minimize a loss.

To do so, the user query processing system 104 receives a plurality of user queries 504 entered via the search feature of the application 108, and including user queries of multiple languages. The user queries 504 are checked for spelling errors against any one of a plurality of publicly available spellcheckers (e.g., Hunspell, Aspell, etc.), and the user queries 504 that include spelling errors are removed.

The remaining user queries 504 that do not include spelling errors are provided to an error injector module 506, which is configured to generate error queries 508 by injecting errors into the user queries 504. The spelling errors are injected based on common spelling error types exhibited across multiple languages. For example, the error injector module 506 injects errors into the user queries 504 using the following techniques: (1) change the order of letters (e.g., “change” to “chnage”), (2) remove or add a vowel (e.g., change “malleable” to “mallable” or “malleiable”), (3) add an additional character to a token (e.g., change “fresh” to “freshh” or “frersh”), (4) replace a character in a token with another character (e.g., change “fresh” to “frash” or “frwsh”), (5) replace accented characters with unaccented counterpart characters (e.g., change “français” to “francais”), (6) remove a character from a string of repeated characters in a token (e.g., change “happiness” to “hapiness”).

The above-described error injection techniques are weighted based on the frequency of the error types. In a specific example, the error injector module 506 injects errors using the error injection techniques (1) through (6) based on a ratio of 7:5:4:2:7:2, e.g., with error injection (1) being selected seven times, error injection technique (2) being selected five times, and so on. Thus, the error injector module 506 generates a training dataset 510 that includes the correctly spelled user queries 504 and corresponding error queries 508 which each include one or more injected spelling errors.

An error query 508 is provided to the suggester module 122, which generates candidate tokens 124 for the one or more misspelled tokens of the error query 508 in accordance with the described techniques. Further, the candidate tokens 124 are provided to the machine learning ranker module 126, which is configured to generate a ranking 308 of the candidate tokens 124 in accordance with the described techniques. A candidate token is selected to replace each misspelled token of the error query 508 based on the ranking. Moreover, a corrected error query 512 that includes the one or more selected tokens 514 rather than the one or more misspelled tokens of the error query 508 is provided to the training module 502. The training module 502 also receives the ground truth user query 504 corresponding to the error query 508. Generally, the training module 502 is configured to adjust the weights of the machine learning ranker module 126 based on a comparison 516 of the ground truth user query 504 to the corrected error query 512.

By way of example, the training module 502 computes a loss between the ground truth user query 504 and the corrected user query 512 using any one of a variety of different loss functions, such as a cross-entropy loss function, an absolute error (L1) loss function, a squared error (L2) loss function, and so on. In examples in which the machine learning ranker module 126 includes one or more MLP networks, the MLP layers of the machine learning ranker module 126 are initialized with an initial set of weights. In these examples, the training module 502 adjusts the weights of the MLP layers of the machine learning ranker module 126 to minimize the loss. Further, the training module 502 iteratively adjusts the weights of the MLP layers of the machine learning ranker module 126 based on the loss between the ground truth user query 504 and the corrected error query 512 determined using the adjusted weights until the loss converges to a minimum. In one or more examples, the loss converges to a minimum when the corrected user query 512 matches the ground truth user query 504. During training, this process is repeated for each ground truth user query 504 and corresponding error query 508. In one or more implementations, updating the weights of the machine learning ranker module 126, in effect, updates the weights assigned to the ranking features 310 on which the ranking 308 of the candidate tokens 124 is generated.

In one or more implementations, the user query processing system 104 is employed to correct misspelled tokens in user queries entered via search features of different applications 108. For instance, the user query processing system 104 is a microservice which is invoked by various different applications. In these implementations, the collection of tokens 112, the permutation index 202, the overrides 204, the search statistics 206, and the application documentation statistics 208 utilized by the user query processing system 104 are different for different applications. Given this, the user query processing system 104 maintains separate collections of tokens 112, separate permutation indexes 202, separate overrides 204, separate search statistics 206, and separate application documentation statistics 208 for each of the different applications 108, e.g., in different databases. Additionally or alternatively, two or more related applications (e.g., two different applications made available by a same service provider) share a collection of tokens 112, a permutation index 202, overrides 204, search statistics 206, and application documentation statistics 208. Accordingly, application usage data 210 received by a respective application 108 is utilized to update the collection of tokens 112, permutation index 202, overrides 204, and search statistics 206 corresponding to the respective application 108.

Further, when the user query processing system 104 receives a user query 106, the user query processing system 104 leverages the collection of tokens 112, permutation index 202, overrides 204, search statistics 206, and application documentation statistics 208 corresponding to the application 108 from which the user query 106 is received. By way of example, the override module 402 searches the overrides 204 corresponding to the application from which the user query is received. Furthermore, the suggester module 122 identifies candidate tokens 124 based on the collection of tokens 112 and the permutation index 202 of the application 108 from which the user query 106 is received. Moreover, the machine learning ranker module 126 generates the rankings of the candidate tokens 124 based on the search statistics 206 (e.g., the query count, the result count, the click rate, and the query success statistics) and the application documentation statistics 208 associated with the application 108 from which the user query is received. The user query processing system 104 improves accuracy in correcting application-specific spelling errors by leveraging a collection of tokens 112, a permutation index 202, overrides 204, search statistics 206, and application documentation statistics 208 that are specific to an application and/or sub-grouping of applications.

In one or more implementations, multiple machine learning ranker modules 126 are separately trained for each of the applications 108 and/or for each sub-grouping of related applications 108. By way of example, the user query processing system 104 receives different sets of user queries 504 for different applications 108 and/or sub-groupings of applications 108. In this way, the training dataset 510 includes different ground truth user queries 504 and different error queries 508 on which the different machine learning ranker modules 126 are trained. As a result, multiple machine learning ranker modules 126 having different weights assigned to the ranking features 310 are leveraged for the different applications. The user query processing system 104 further improves accuracy in correcting application-specific spelling errors by separately training machine learning ranker modules 126 for different applications and/or sub-groupings of applications. In at least one variation, the machine learning ranker module 126 is trained on the user queries 504 of one application 108, and deployed to correct misspelled tokens in user queries received via multiple applications.

As mentioned above, the user query processing system 104 is a microservice that is invoked by different applications 108, in one or more implementations. In particular, the applications 108 communicate with a microservice orchestrator which invokes the functionality of the user query processing system 104. In one or more implementations, a low latency bridge (e.g., an East-West Connection) is established between the microservice orchestrator and the user query processing system 104. Broadly, the low latency bridge ensures that the microservice orchestrator and the user query processing system are deployed within a same availability zone, e.g., within a same regional datacenter. Therefore, the low latency bridge reduces a physical distance between the microservice orchestrator and the user query processing system 104, as compared to other interservice connections, thereby reducing a latency for servicing multiple successive spell correction requests.

### Example System and Device

FIG. 9 illustrates an example system generally at 900 that includes an example computing device 902 that is representative of one or more computing systems and/or devices that implement the various techniques described herein. This is illustrated through inclusion of the user query processing system 104. The computing device 902 is configurable, for example, as a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interface 908 that are communicatively coupled, one to another. Although not shown, the computing device 902 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that is configurable as processors, functional blocks, and so forth. This includes implementation in hardware as an application specific integrated circuit or other logic device formed using one or more semiconductors. The hardware elements 910 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 906 is illustrated as including memory/storage 912. The memory/storage 912 represents memory/storage capacity associated with one or more computer-readable media. The memory/storage 912 includes volatile media (such as random access memory (RAM)) and/or nonvolatile media (such as read only memory (ROM), Flash memory, optical disks, magnetic disks, and so forth). The memory/storage 912 includes fixed media (e.g., RAM, ROM, a fixed hard drive, and so on) as well as removable media (e.g., Flash memory, a removable hard drive, an optical disc, and so forth). The computer-readable media 906 is configurable in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 902. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 902, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 910. The computing device 902 is configured to implement particular instructions and/or functions corresponding to the software and/or hardware modules. Accordingly, implementation of a module that is executable by the computing device 902 as software is achieved at least partially in hardware, e.g., through use of computer-readable storage media and/or hardware elements 910 of the processing system 904. The instructions and/or functions are executable/operable by one or more articles of manufacture (for example, one or more computing devices 902 and/or processing systems 904) to implement techniques, modules, and examples described herein.

The techniques described herein are supported by various configurations of the computing device 902 and are not limited to the specific examples of the techniques described herein. This functionality is also implementable all or in part through use of a distributed system, such as over a “cloud” 914 via a platform 916 as described below.

The cloud 914 includes and/or is representative of a platform 916 for resources 918. The platform 916 abstracts underlying functionality of hardware (e.g., servers) and software resources of the cloud 914. The resources 918 include applications and/or data that can be utilized while computer processing is executed on servers that are remote from the computing device 902. Resources 918 can also include services provided over the Internet and/or through a subscriber network, such as a cellular or Wi-Fi network.

The platform 916 abstracts resources and functions to connect the computing device 902 with other computing devices. The platform 916 also serves to abstract scaling of resources to provide a corresponding level of scale to encountered demand for the resources 918 that are implemented via the platform 916. Accordingly, in an interconnected device embodiment, implementation of functionality described herein is distributable throughout the system 900. For example, the functionality is implementable in part on the computing device 902 as well as via the platform 916 that abstracts the functionality of the cloud 914.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

1. A method comprising:
receiving, by a processing device, a user query entered via a search feature of an application;
identifying, by the processing device, a misspelled token in the user query;
identifying, by the processing device and using a symmetric delete algorithm, candidate tokens to replace the misspelled token from a collection of tokens;
generating, by a machine learning model implemented by the processing device, a ranking of the candidate tokens based on a frequency of occurrence of the candidate tokens in user queries entered via the search feature of the application;
selecting, by the processing device, a token from the candidate tokens based on the ranking; and
outputting, by the processing device, the selected token.

2. The method of claim 1, wherein the collection of tokens includes:
tokens corresponding to features of the application;
tokens having at least a threshold frequency of occurrence in the user queries entered via the search feature of the application; or
tokens of multiple languages.

3. The method of claim 1, wherein the identifying the candidate tokens includes building a permutation index including permutations of correctly spelled tokens in the collection of tokens.

4. The method of claim 3, wherein the identifying the candidate tokens includes generating variations of the misspelled token that are less than a threshold number of edit distances from the misspelled token, and identifying the correctly spelled tokens in the collection of tokens by matching the permutations of the correctly spelled tokens with the variations of the misspelled token.

5. The method of claim 4, wherein the identifying the candidate tokens includes generating additional variations of the misspelled token that are greater than or equal to the threshold number of edit distances from the misspelled token based on less than a threshold number of the correctly spelled tokens being identified from the variations.

6. The method of claim 5, wherein the identifying the candidate tokens includes identifying additional correctly spelled tokens in the collection of tokens by matching the permutations of the additional correctly spelled tokens with the additional variations of the misspelled token.

7. The method of claim 5, wherein the generating the variations and the additional variations includes performing edits on individual characters of the misspelled token, the edits including deletes and not inserts, transposes, and replaces.

8. The method of claim 1, wherein the ranking is further based on:
a quantity of search results of the application that the candidate tokens produce;
a click rate associated with the search results of the application that the candidate tokens produce; and
linguistic features associated with the candidate tokens.

9. The method of claim 1, further comprising:
receiving, by the processing device, application usage data including a plurality of user queries entered via the search feature of the application; and
updating, by the processing device, the collection of tokens to include additional tokens from the plurality of user queries.

10. The method of claim 1, further comprising:
identifying, by the processing device, a corrected token corresponding to the misspelled token in a database of overrides;
bypassing, by the processing device, the identifying the candidate tokens and the generating based on the misspelled token being included in the database; and
outputting, by the processing device, the corrected token.

11. The method of claim 1, further comprising:
receiving, by the processing device, a plurality of user queries entered via the search feature of the application;
generating, by the processing device, training data by injecting errors into the plurality of user queries; and
training, by the processing device, the machine learning model using the training data.

12. A system comprising:
an input module implemented by one or more processing devices to receive a user query entered via a search feature of an application and identify a misspelled token in the user query;
a suggester module implemented by the one or more processing devices to identify candidate tokens to replace the misspelled token from a collection of tokens;
an error injector module implemented by the one or more processing devices to generate a dataset including user queries entered via the search feature of the application, and error queries by injecting errors of different types at different frequencies into the user queries;
a ranker module implemented by the one or more processing devices to generate a ranking of the candidate tokens, the ranker module trained using machine learning on the dataset; and
an output module implemented by the one or more processing devices to select a token from the candidate tokens based on the ranking and output the selected token.

13. The system of claim 12, wherein the suggester module is further configured to build a permutation index including permutations of correctly spelled tokens in the collection of tokens.

14. The system of claim 13, wherein the suggester module is further configured to:
generate variations of the misspelled token that are less than a threshold number of edit distances from the misspelled token; and
identify the correctly spelled tokens in the collection of tokens by matching the permutations of the correctly spelled tokens with the variations of the token.

15. The system of claim 14, wherein the suggester module is further configured to:
generate additional variations of the misspelled token that are greater than or equal to the threshold number of edit distances from the misspelled token based on less than a threshold number of the correctly spelled tokens being identified from the variations; and
identify additional correctly spelled tokens in the collection of tokens by matching the permutations of the correctly spelled tokens with the additional variations of the misspelled token.

16. The system of claim 12, wherein the dataset of user queries includes user queries of multiple languages.

17. A non-transitory computer-readable storage medium storing executable instructions, which when executed by a processing device, cause the processing device to perform operations comprising:
receiving a user query entered via a search feature of an application;
identifying a misspelled token in the user query;
determining whether the misspelled token is included in a database of overrides;
responsive to the misspelled token not being included in the database:
identifying, using a symmetric delete algorithm, candidate tokens to replace the misspelled token from a collection of tokens;
generating, by a machine learning model, a ranking of the candidate tokens based on a quantity and click rate of search results of the application that the candidate tokens produce;
selecting a token of the candidate tokens based on the ranking; and
outputting the selected token;
responsive to the misspelled token being included in the database:
identifying a corrected token in the database corresponding to the misspelled token;
bypassing the identifying and the generating the ranking of the candidate tokens; and
outputting the corrected token.

18. The non-transitory computer-readable storage medium of claim 17, wherein the collection of tokens includes:
tokens corresponding to features of the application;
tokens having at least a threshold frequency of occurrence in user queries entered via the search feature of the application; or
tokens of multiple languages.

19. The non-transitory computer-readable storage medium of claim 17, wherein the ranking is further based on:
a frequency of occurrence of the candidate tokens in queries entered via the search feature of the application; and
linguistic features associated with the candidate tokens.

20. The non-transitory computer-readable storage medium of claim 19, the operations further including:
receiving application usage data including a plurality of user queries entered via the search feature of the application, search results of the plurality of user queries, and user interactions with the search results of the plurality of user queries; and
updating the frequency of occurrence, the quantity of the search results, and the click rate of the search results associated with tokens in the collection of tokens based on the application usage data.
